(19) United States
(12) Patent Application Publication
(10) Pub. No.: US 2015/0243957 A1
(43) Pub. Date: Aug. 27, 2015

(54) RECHARGEABLE BATTERY MODULE

(71) Applicant: SAMSUNG SDI CO., LTD., Yongin-si (KR)

(72) Inventors: Min-Yeol HAN, Yongin-si (KR); Sang-Won BYUN, Yongin-si (KR)

(21) Appl. No.: 14/533,230

(22) Filed: Nov. 5, 2014

(30) Foreign Application Priority Data
Feb. 21, 2014 (KR) 10-2014-0020784

(51) Int. Cl. H01M 2/34; H01M 2/20; H01M 2/26; H01M 2/04; H01M 2/30

(52) U.S. Cl. CPC H01M 2/34; H01M 2/04; H01M 2/30; H01M 2/26; H01M 2/202; H01M 2/0404; H01M 2/043; H01M 2/204; H01M 2/206; H01M 2200/00; H01M 2220/20; H01M 2220/30

(57) ABSTRACT

A rechargeable battery module includes unit battery cells and a bus bar connecting the unit battery cells in parallel. Each unit battery cell includes a cap plate, a case that accommodates an electrode assembly, lead tabs connected to the electrode assembly, one of the lead tabs including a cell fuse, first and second electrode terminals that penetrate the cap plate and are connected to the lead tabs, and an external short-circuit part including a membrane that seals a short-circuit hole of the cap plate and that is electrically connected to the second electrode terminal and a connection plate that is electrically connected to the first electrode terminal. The bus bar includes two current paths that connect neighboring second electrode terminals through different resistances, one of the two current paths including an external fuse. A resistance of the external fuse is greater than a resistance of the cell fuse.

### CROSS-REFERENCE TO RELATED APPLICATION

Korean Patent Application No. 10-2014-0020784, filed on Feb. 21, 2014, in the Korean Intellectual Property Office, and entitled: “Rechargeable Battery Module,” is incorporated by reference herein in its entirety.

### BACKGROUND

1. Field

Embodiments relate to a rechargeable battery module in which unit battery cells are connected in parallel.

2. Description of the Related Art

A rechargeable battery differs from a primary battery in that it can be repeatedly charged and discharged, while the latter is incapable of being recharged.

A low-capacity rechargeable battery is used in small portable electronic devices such as mobile phones, notebook computers, and camcorders, while a high-capacity rechargeable battery can be used as a power source for driving a motor of a hybrid vehicle and an electric vehicle.

The rechargeable battery may be used in small electronic devices as a single cell battery, or in motor-driving power sources, etc. as a battery module in which a plurality of battery cells are electrically connected.

### SUMMARY

Embodiments are directed to a rechargeable battery module including a plurality of unit battery cells and a bus bar connecting the unit battery cells in parallel. Each unit battery cell includes a cap plate sealing an opening of a case that accommodates an electrode assembly, lead tabs connected to the electrode assembly, one of the lead tabs including a cell fuse, first and second electrode terminals that penetrate the cap plate, the first and second electrode terminals being connected to the lead tabs, and an external short-circuit part including a membrane that seals a short-circuit hole of the cap plate and that is electrically connected to the second electrode terminal and a connection plate that is electrically connected to the first electrode terminal. The bus bar includes two current paths that connect neighboring second electrode terminals through different resistances, one of the two current paths including an external fuse. A resistance of the external fuse is greater than a resistance of the cell fuse.

The bus bar may include a first connecting member that connects the neighboring second electrode terminals to form one current path of the two current paths, the first connecting member including the external fuse, and a second connecting member that connects the neighboring second electrode terminals to form another current path of the two current paths, the second connecting member having a resistance greater than the resistance of the external fuse.

The first connecting member may include a plurality of welding plates, each welding plate being welded onto the second electrode terminal of a respective one of the unit battery cells. The external fuse may interconnect the plurality of welding plates.

The second connecting member may be in a form of a plate that welded onto the welding plates of the first connecting member.

The second electrode terminal may include a rivet terminal in a terminal hole of the cap plate, a flange integral with the rivet terminal at an inner side of the cap plate; and a plate terminal connected to the rivet terminal, the plate terminal being positioned at an outer side of the cap plate. One of the welding plates of the first connecting member may be welded to the plate terminal.

The first connecting member may be made of aluminum or an aluminum alloy.

The second connecting member may be made of steel or stainless steel.

The external fuse may include a plurality of external fuses, a number of the external fuses may be one less than a number of the unit battery cells such that each of the external fuses may be correspondingly disposed between neighboring unit battery cells.

### BRIEF DESCRIPTION OF THE DRAWINGS

Features will become apparent to those of skill in the art by describing in detail exemplary embodiments with reference to the attached drawings in which:

FIG. 1 illustrates a perspective view of a rechargeable battery module according to an exemplary embodiment.

FIG. 2 illustrates a top plan view of FIG. 1.

FIG. 3 illustrates an exploded perspective view of a bus bar that is applicable to the rechargeable battery module of FIG. 1.

FIG. 4 illustrates a perspective view of a unit battery cell that is applicable to the rechargeable battery module of FIG. 1.

FIG. 5 illustrates a cross-sectional view of FIG. 4 taken along the line V-V.

FIG. 6 illustrates a circuit diagram of the rechargeable battery module of FIG. 1.

FIG. 7 illustrates a circuit diagram depicting current flows in FIG. 6 while a membrane of an external short-circuit part is short-circuited.

FIG. 8 illustrates a circuit diagram depicting current flows subsequent to the state illustrated in FIG. 7 while an external fuse provided in the bus bar is cut off

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

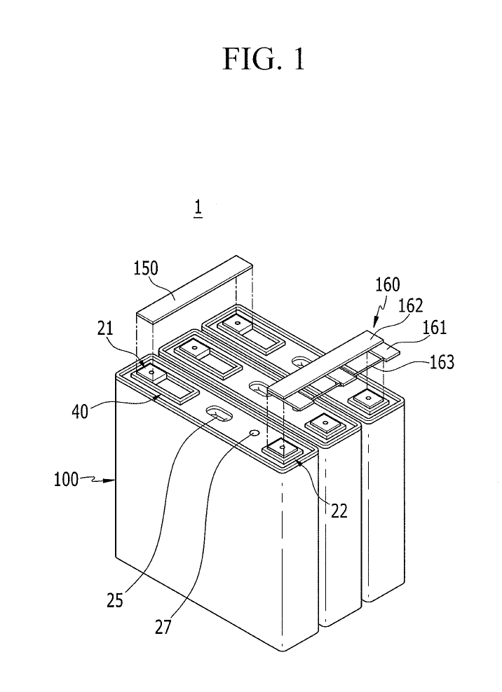

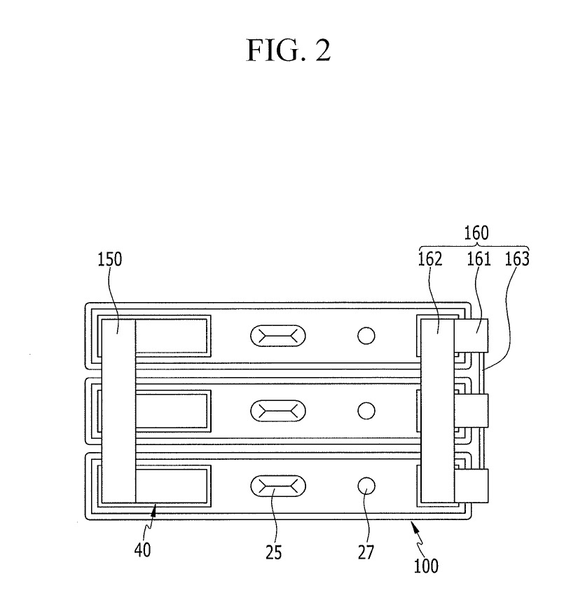

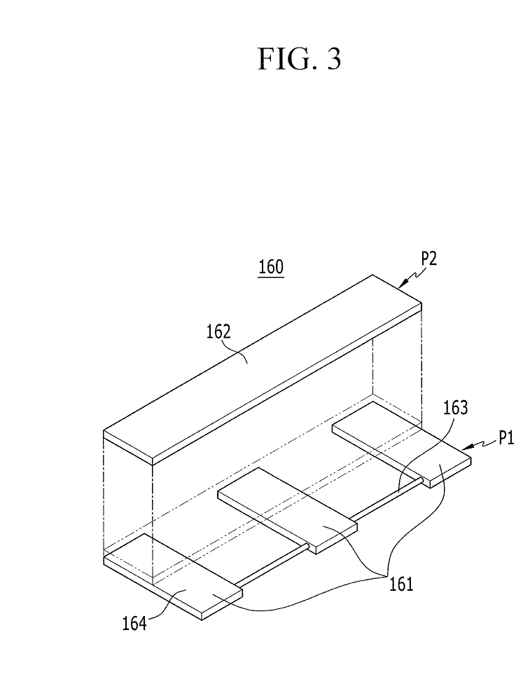

FIG. 1 illustrates a perspective view of a rechargeable battery module according to an exemplary embodiment, FIG. 2 illustrates a top plan view of FIG. 1, and FIG. 3 illustrates an exploded perspective view of a bus bar that is applicable to the rechargeable battery module of FIG. 1.

Referring to FIGS. 1 to 3, a rechargeable battery module 1 according to the exemplary embodiment includes unit battery cells 100 that are rechargeable batteries, and first and second bus bars 150 and 160 that interconnect the unit battery cells 100 in parallel.

The rechargeable battery module may be formed by connecting two or more unit battery cells 100 in parallel. For convenience of illustration and description, the current exemplary embodiment is illustrated as connecting three unit battery cells 100 in parallel with the first and second bus bars 150 and 160 so as to form the rechargeable battery module.

The first bus bar 150 may electrically interconnect first electrode terminals 21 of the unit battery cells 100, and the second bus bar 160 may electrically interconnect second electrode terminals 22 of the unit battery cells 100.

Hereinafter, for convenience of description, the first electrode terminal 21 is referred to as a negative terminal, and the second electrode terminal 22 is referred to as a positive terminal.

The first bus bar 150 may form one current path that connects neighboring negative terminals 21. The second bus bar 160 may be configured to connect neighboring positive terminals 22 by way of two current paths P1 and P2. The two current paths P1 and P2 may have different resistances.

The second bus bar 160 may be provided with an external fuse 163 in one current path P1 among the two current paths P1 and P2. For example, the current path P1 with the external fuse 163 may have lower resistance than the current path P2 without the external fuse 163. An amount of current exceeding a predetermined value among a total amount of current discharged from and charged to the positive electrode terminals 22 may flow through the external fuse 163.

The resistance of the current path P2 without the external fuse 163 may be equal to that of the first bus bar 150.

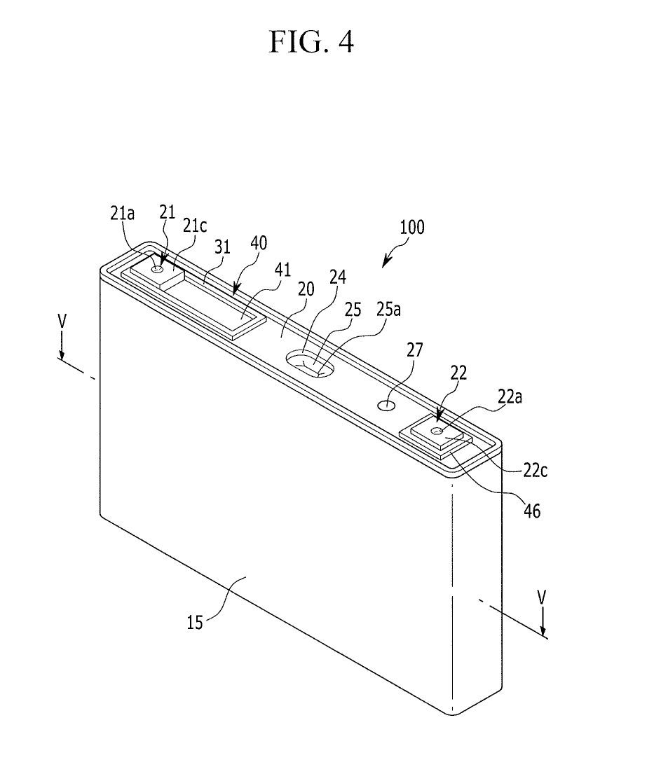

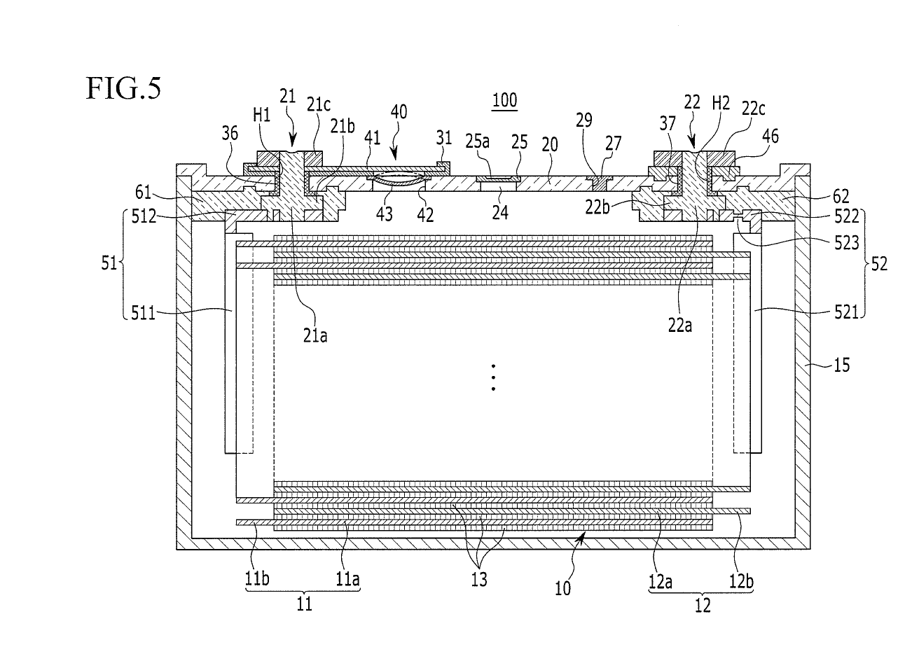

FIG. 4 illustrates a perspective view of a unit battery cell that is applicable to the rechargeable battery module of FIG. 1, and FIG. 5 illustrates a cross-sectional view of FIG. 4 taken along the line V-V.

Referring to FIGS. 4 and 5, the unit battery cell 100 may include an electrode assembly 10 to charge and discharge a current, a case 15 that accommodates the electrode assembly 10, a cap plate 20 that seals an opening of the case 15, first and second lead tabs 51 and 52 connected to the electrode assembly 10 (for convenience, referred to hereinafter as “negative/positive electrode lead tabs”), the first and second electrode terminals 21 and 22, which are provided to penetrate the cap plate 20 while being connected to the negative and positive lead tabs 51 and 52, and an external short-circuit part 40 provided in the negative terminal 21.

For example, the electrode assembly 10 may be formed by positioning a first electrode 11 (hereinafter referred to as “negative electrode”) and a second electrode 12 (hereinafter referred to as “positive electrode”) on opposite sides of a separator 13, which is an insulator, and then spirally winding the negative electrode 11, the separator 13, and the positive electrode 12 in a jelly-roll state.

The negative and positive electrodes 11 and 12 may include coated regions 11a and 12a where an active material is coated on a current collector formed of a thin metal foil, and uncoated regions 11b and 12b where the active material is not coated thereon so as to form an exposed current collector.

The uncoated region 11b of the negative electrode 11 may be formed at one end thereof along the spirally wound negative electrode 11. The uncoated region 11b of the positive electrode 12 may be formed at the other end thereof along the spirally wound positive electrode 12 such that he uncoated regions 11b and 12b are disposed at opposite ends of the electrode assembly 10.

The case 15 may formed approximately in a cuboid shape to accommodate the electrode assembly 10 and an electrolyte solution. The case 15 may include the opening in one surface of the cuboid that connects external and internal spaces. The opening may allow the electrode assembly 10 to be inserted into the case 15. The cap plate 20 may be provided in the opening of the case 15 to seal the case 15.

The case 15 and the cap plate 20 may be made of a same material, such as aluminum. The case 15 and the cap plate 20 may be strongly welded to each other.

The cap plate 20 may be provided with an electrolyte injection opening 29, a vent hole 24, and terminal holes H1 and H2. The electrolyte injection opening 29 may allow the electrolyte solution to be injected into the case 15 after the cap plate 20 is combined with the case 15. After the electrolyte solution is injected into the case 15, the electrolyte injection opening 29 may be sealed with a sealing cap 27.

To discharge an internal pressure of the unit battery cell 100, the vent hole 24 may be sealed with a vent plate 25 welded thereto. The vent plate 25 may be ruptured to open the vent hole 24 when the internal pressure of the unit battery cell 100 reaches a predetermined pressure. The vent plate 25 may be provided with a notch 25a that induces the rupture.

The negative and positive terminals 21 and 22 may be provided in the terminal holes H1 and H2 of the cap plate 20, and may be electrically connected to the electrode assembly 10 through the negative and positive lead tabs 51 and 52. The negative terminal 21 may be electrically connected to the negative electrode 11 of the electrode assembly 10, while the positive terminal 22 may be electrically connected to the positive electrode 12 of the electrode assembly 10. Electrical energy generated by electrode assembly 10 may be drawn out of the case 15 through the negative and positive terminals 21 and 22.

The negative and positive terminals 21 and 22 may have the same structure at an inner side of the cap plate 20. Accordingly, the same structures will be described together. The negative and positive terminals 21 and 22 at an outer side of the cap plate 20 may have different structures and will be separately described.

The negative and positive terminals 21 and 22 may include rivet terminals 21a and 22a respectively provided into the terminal holes H1 and H2 of the cap plate 20, flanges 21b and 22b widely formed at the inner side of the cap plate 20, the flanges 21b and 22b being integrally formed with the rivet terminals 21a and 22a, and plate terminals 21c and 22c connected to the rivet terminals 21a and 22a by riveting or welding, the plate terminals 21c and 22c being disposed outside of the cap plate 20.

Negative and positive gaskets 36 and 37 may be respectively provided between the rivet terminals 21a and 22a of the negative and positive terminals 21 and 22 and the inner sides of the terminal holes H1 and H2 of the cap plate 20 to seal and electrically insulate between the rivet terminals 21a and 22a of the negative and positive terminals 21 and 22 and the cap plate 20. The negative and positive gaskets 36 and 37 may be elongated to be between the flanges 21b and 22b and the inner side of the cap plate 20 to seal and electrically insulate between the flanges 21b and 22b and the cap plate 20. The negative and positive gaskets 36 and 37 may prevent leakage of the electrolyte solution through the terminal holes H1 and H2.

The negative and positive electrode lead tabs 51 and 52 may be provided with current collecting portions 511 and 521 that are vertically bent at one side, and connecting portions 512 and 522 connected thereto. The connecting portions 512 and 522 may be electrically connected to the negative and positive terminals 21 and 22 and electrically connected to the negative and positive electrodes 11 and 12 of the electrode assembly 10.

The connecting portions 512 and 522 of the negative and positive lead tabs 51 and 52 may be connected to the lower end portions of the rivet terminals 21a and 22a by combining the connecting portions 512 and 522 of the negative and positive electrode lead tabs 51 and 52 with lower end portions of the rivet terminals 21a and 22a and then caulking the lower end portions. The connecting portions 512 and 522 may be supported by the flanges 21b and 22b.

The positive lead tab 52 may be provided with a cell fuse 523 in the connecting portion 522. The cell fuse 523 may be formed to have a smaller width than the connecting portion 522, and may control a current flow from the current collecting portion 521 connected to the positive electrode 12 to the connecting portion 522. If the cell fuse 523 is cut off by melting, current ceases to flow from the electrode assembly 10 of the unit battery cell 100 to the positive terminal 22.

Resistance of the external fuse 163 may be set to be smaller than that of the cell fuse 523. When the external short-circuit part 40 of the unit battery cell 100 is short-circuited, first the external fuse 163 may be cut off by melting, and then the cell fuse 523 may be cut off by melting.

Accordingly, parallel connections of the unit battery cells 100 may be cut off while maintaining a short-circuit state of the external short-circuit part 40. While the external short-circuit part 40 is short-circuited and the parallel connections of the unit battery cells 100 are cut off, a charged current in the electrode assembly 10 of the unit battery cell 100 that is short-circuited by the external short-circuit part 40 may be discharged to the positive terminal 22 through the cell fuse 523. In this case, the external fuse 163 may be cut off by melting and then the cell fuse 523 provided in the positive electrode lead tab 52 may be cut off by melting.

Negative and positive insulating members 61 and 62 may be respectively provided between the connecting portions 512 and 522 of the negative and positive lead tabs 51 and 52 and the cap plate 20 for electrical insulation. The negative and positive insulating members 61 and 62 may be coupled to the cap plate 20 at one side thereof and at the other side thereof, and may enclose the connecting portions 512 and 522 of the negative and positive lead tabs 51 and 52, the rivet terminals 21a and 22a, and the flanges 21b and 22b, thereby stabilizing a connecting structure between them.

The external short-circuit part 40 will be described in connection with the plate terminal 21c of the negative terminal 21, and a top plate 46 will be described in connection with the plate terminal 22c of the positive terminal 22.

The external short-circuit part 40 may include a connection plate 41 and a membrane 43, which are disposed to be spaced apart from each other or short-circuited with each other, depending on the internal pressure of the unit battery cell 100. The connection plate 41 may be disposed outside of the cap plate 20 and may be electrically connected to the rivet terminal 21a of the negative terminal 21. An insulating member 31 may be disposed between the connection plate 41 and the cap plate 20 for electrical insulation. The cap plate 20 may maintain an electrically insulated state with respect to the negative terminal 21.

The connection plate 41 and the plate terminal 21c may be coupled to the upper part of the rivet terminal 21a by combining the connection plate 41 and the plate terminal 21c to an upper part of the rivet terminal 21a and then caulking the upper part thereof. The connection plate 41 and the plate terminal 21c may be fastened to the cap plate 20 with the insulating member 31 interposed therebetween. Thus, the connection plate 41 and the plate terminal 21c may be insulated from the cap plate 20.

The membrane 43 may be welded in a short-circuit hole 42 formed in the cap plate 20 such that the membrane 43 seals the short-circuit hole 42.

Being connected to the negative terminal 21, the connection plate 41 is disposed to extend from opposite ends of the membrane 43. The connection plate 41 and the membrane 43 correspond to the short-circuit hole 42, face each other to maintain a separated state (solid line state), and may form a short-circuit state (imaginary line state) in which the membrane 43 is inversely deformed when the internal pressure of the unit battery cells 100 increases.

The top plate 46 adjacent to the positive terminal 22 may electrically connect the plate terminal 22c of the positive terminal 22 with the cap plate 20. For example, the top plate 46 may be interposed between the plate terminal 22c and the cap plate 20, and may be penetrated by the rivet terminal 22a. The top plate 46 and the plate terminal 22c may be coupled to the upper part of the rivet terminal 22a by combining the top plate 46 and the plate terminal 22c with the upper part of the rivet terminal 22a and then caulking the upper part thereof.

The plate terminal 22c may be provided at the outer side of the cap plate 20, with the top plate 46 being interposed therebetween.

The positive gasket 37 may be provided so as to be further elongated between the rivet terminal 22a and the top plate 46. The positive gasket 37 may prevent the rivet terminal 22a from being directly electrically connected to the top plate 46. Instead, the rivet terminal 22a may be electrically connected to the top plate 46 and the cap plate 20 through the plate terminal 22c.

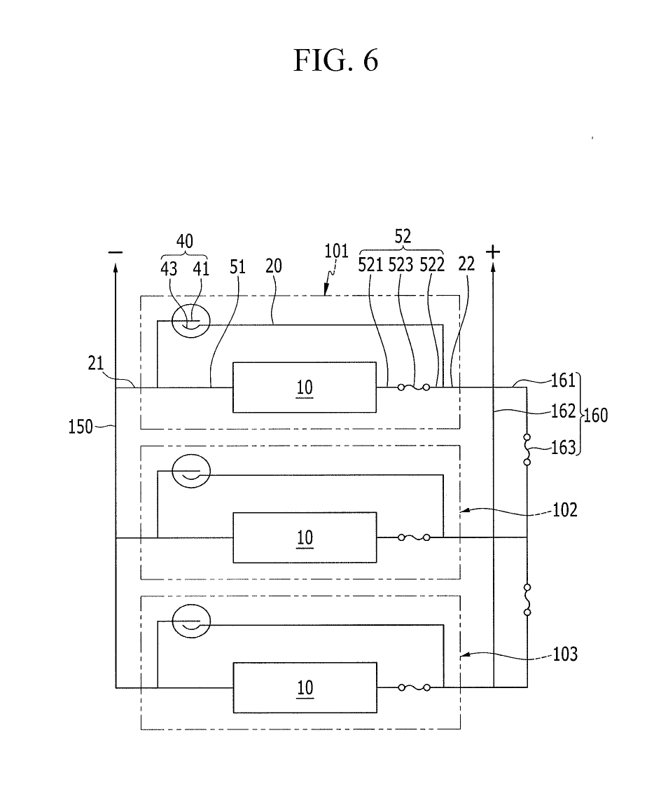

FIG. 6 illustrates a circuit diagram of the rechargeable battery module of FIG. 1.

Referring to FIGS. 1 to 3 and 6, the second bus bar 160 may include a first connecting member 161 and a second connecting member 162 that form two current paths P1 and P2.

The first connecting member 161 may form one current path P1, having the external fuse 163 of a first resistance interposed, and may electrically connect the neighboring positive terminals 22

The second connecting member 162 may form another current path P2, and may electrically connect the neighboring positive terminals 22. The second connecting member 162 may have a second resistance that is greater than the first resistance.

For example, the first connecting member 161 may include a plurality of welding plates 164 that are welded onto the positive terminals 22. For example, each welding plate 164 may be welded to the plate terminal 22c of the positive terminal 22 of a respective one of the unit battery cells 100.

The external fuse 163 may interconnect the neighboring welding plates 164 to form the one current path P1.

The second connecting member 162 may have a plate form and may be welded onto the welding plates 164 to form another current path P2.

The first connecting member 161 and the external fuse 163 may be formed of aluminum or an aluminum alloy, for example. The second connecting member 162 may be formed of steel or stainless steel having greater resistance than the first connecting member 161.

The external fuses 163 may be integrally formed with the welding plates 164.

The external fuses 163 may be formed in a number that is one less than the number of unit battery cells 100. The external fuses 163 may be correspondingly disposed between the neighboring unit battery cells 100.

Thus, when a particular the external fuse 163 is cut off by melting, the current path P1 between the neighboring unit battery cells 100 is disconnected.

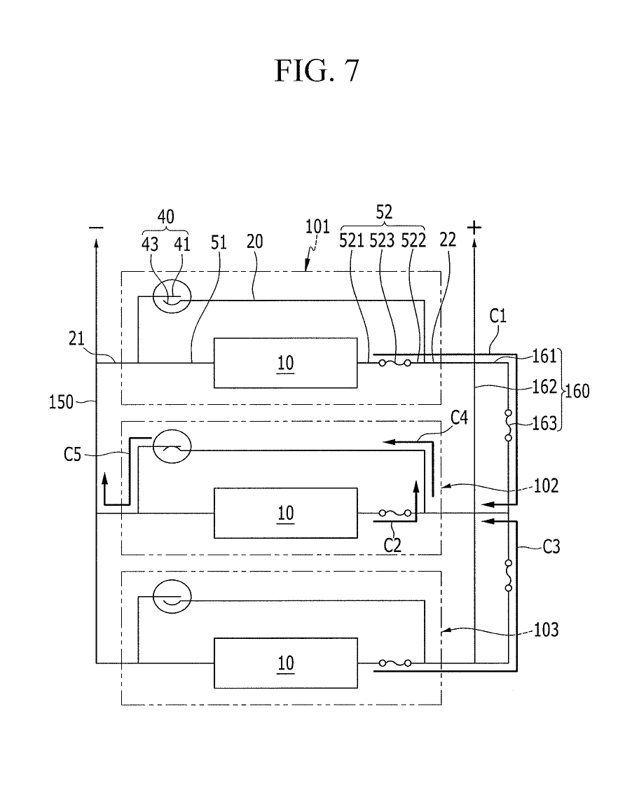

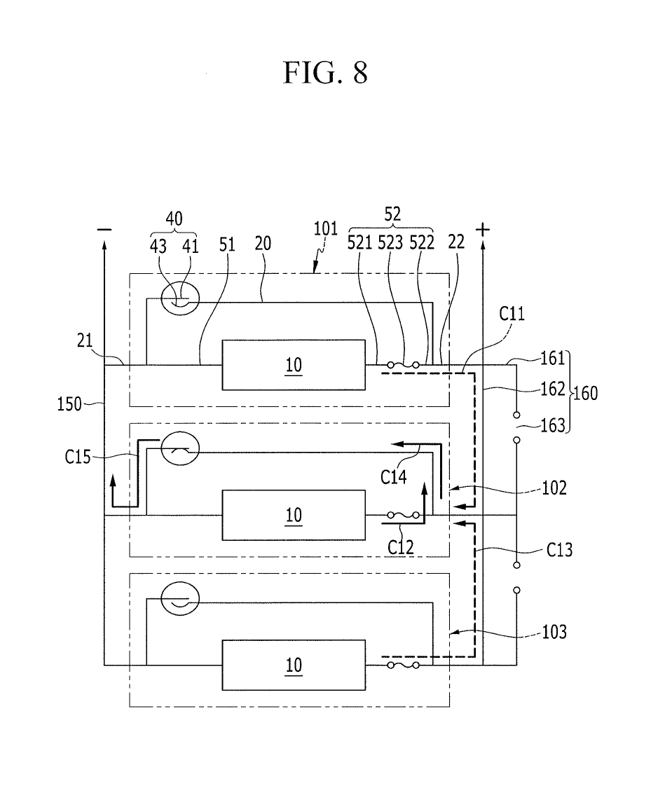

FIG. 7 illustrates a circuit diagram depicting current flows in FIG. 6 when the membrane of the external short-circuit part is short-circuited, and FIG. 8 illustrates a circuit diagram depicting current flows subsequent to a state of FIG. 7 when the external fuse provided in the bus bar is cut off.

Referring FIGS. 6, 7, and 8, a mechanism in which parallel connections are cut off in the rechargeable battery module when the connection plate 41 of the external short-circuit part 40 and the membrane 43 are short-circuited will now be described.

For convenience, the unit battery cells 100 are referred to as first, second, and third unit battery cells 101, 102, and 103.

The rechargeable battery module, as shown in FIG. 6, connects the first, second, and third unit battery cells 101, 102, and 103 in parallel so as to be charged and discharged.

During use of the rechargeable battery module, the external short-circuit part 40 of the second unit battery cell 102, as an example, may be short-circuited due to the increased internal pressure of the second unit battery cell 102.

For convenience of description, as shown in FIG. 7, a state in which the external short-circuit part 40 of the second unit battery cell 102 positioned in between the first unit battery cell 101 and the third unit battery cell 103 is short-circuited will be exemplarily described. It is to be understood that a similar description is applicable in the case that the first unit battery cell 101 or the third unit battery cell 103 is short-circuited.

When the external short-circuit part 40 of the second unit battery cell 102 is short-circuited, current of the first and third unit battery cells 101 and 103 may flow out of the respective positive terminal 22 by sequentially passing through the electrode assembly 10, the current collecting portion 521, the cell fuse 523, and the positive electrode lead tab 52, respectively (in arrow directions C1 and C3).

Next, the current of the first and third unit battery cells 101 and 103 may flow into the second unit battery cell 102 through the positive terminal 22, the first connecting member 161 of the second bus bar 160, the external fuse 163, and the first connecting member 161, and then may flow through the first bus bar 150 by sequentially passing through the top plate 46 of the second unit battery cell 102, the cap plate 20, the membrane 43, the connection plate 41, and the negative terminal 21 (C4 and C5).

In this case, the current of the second unit battery cell 102 may flow out of the positive terminal 22 by sequentially passing through the electrode assembly 10, the current collecting portion 521, the cell fuse 523, and the positive electrode lead tab 52 (in an arrow direction C2).

Next, the current of the second unit battery cell 102, together with the current of the first and third unit battery cells 101 and 103, may flow through the first bus bar 150 by sequentially passing through the top plate 46 of the positive terminal 22, the membrane 43 of the external short-circuit part 40, the connection plate 41, and the negative terminal 21 (in the arrow directions C4 and C5).

In this case, as shown in FIG. 8, the external short-circuit part 40 of the second unit battery cell 102 is in a short-circuit state. Accordingly, the current of the first and third unit battery cells 101 and 103 may flow through the first connecting member 161 of the second bus bar 160 and the external fuse 163 in a large amount.

Due to the large amount of current, the external fuse 163 may be cut off by melting earlier than the cell fuse 523.

As shown in FIG. 8, when the external fuse 163 is cut off by melting, the currents of the first and third unit battery cells 101 and 103 may flow into the positive terminal 22 of the second unit battery cell 102 through the second connecting member 162 of the second bus bar 160 (in arrow directions C11 and C12).

The second connecting member 162 has greater resistance than the first connecting member 161 and the external fuse 163. Accordingly, an amount of current flowing in the arrow directions C11 and C12 may be smaller compared with the amount of current flowing in the arrow directions C1 and C3 before the external fuse 163 is cut off by melting.

The current of the second unit battery cell 102 may flow out of the positive terminal 22 by sequentially passing through the electrode assembly 10, the current collecting portion 521, the cell fuse 523, and the positive electrode lead tab 52 (in the arrow direction C12).

The current of the second unit battery cell 102, together with the current of the first and third unit battery cells 101 and 103, may flow through the first bus bar 150 after sequentially passing through the top plate 46 of the positive terminal 22, the cap plate 20, the membrane 43 of the external short-circuit part 40, the connection plate 41, and the negative terminal 21 (in arrow directions C14 and C15).

Before the external fuse 163 is cut off by melting, the amounts of currents flowing from the first, second, and third unit battery cells 101, 102, and 103 to the positive terminal 22 may have the same ratio (for example, the ratio may be expressed as C1:C2:C3=1:1:1)

However, after the external fuse 163 is cut off by melting, the amount of current flowing from the first and third unit battery cells 101 and 103 may be smaller compared with the amount of current flowing from the second unit battery cell 102 to the positive terminal 22 (for example, the ratio may be expressed as C11:C12:C13=0.9:1.2:0.9)

Thus, while the external short-circuit part 40 is short-circuited, the cell fuse 523 of the second unit battery cell 102 may be cut off first by melting.

Accordingly, a total size of the cell fuses 523 positioned inside the rechargeable battery module (a size of the cell fuses 523 of the first and third unit battery cells 101 and 103 compared with a total size of the cell fuses 523 of the first, second, and the third unit battery cells 101, 102, and 103) may be reduced.

In a rechargeable battery module in which the first, second, and the third unit battery cells 101, 102, and 103 are connected in parallel, the parallel connections may be instantly cut off.

A membrane malfunction may be prevented in which the membrane 43 of the external short-circuit part 40 is short-circuited with the connection plate 41 and is then cut off by melting again before the parallel connections of the first, second, and the third unit battery cells 101, 102, and 103 are cut off.

Though not separately illustrated, referring to FIGS. 6 to 8, the second bus bar 160 of the exemplary embodiment may be identically applied to a rechargeable battery module in which two unit battery cells 100 are connected in parallel.

Even in this case, after the external fuse 163 provided in the second bus bar 160 is cut off by melting while the external short-circuit part 40 is short-circuited, the cell fuse 523 may be cut off by melting.

By way of summation and review, a rechargeable battery module may be formed by connecting electrode terminals of unit battery cells with bus bars. A unit battery cell is provided with a cell fuse in a lead tab that connects an electrode assembly to an electrode terminal.

The cell fuse may be melted and cut off due to an overcurrent such that ignition or explosion of the unit battery cell from overcharge or overcurrent may be prevented.

In order to discharge a current charged in the electrode assembly, the unit battery cell may be provided with an external short-circuit part configured to allow a membrane to be short-circuited with a connection plate outside of the electrode assembly. The external short-circuit part short-circuits positive and negative electrodes outside of the electrode assembly when the internal pressure of the unit battery cell increases above a predetermined limit so as to discharge the current charged in the electrode assembly.

The rechargeable battery module may be formed by connecting a plurality of unit battery cells in parallel through the bus bars. In this case, as the cell fuses provided in the unit battery cells are connected in parallel to increase a current capacity thereof, a larger amount current is required to melt and cut off the cell fuse. The amount of current required to melt and cut off the cell fuse may be higher than that required to melt and cut off the membrane and the connection plate of the external short circuit part after the external short circuit part is short-circuited.

Accordingly, a time at which the cell fuse is cut off by melting may be later than a time at which the membrane of the external short circuit part melts and is cut off from the connection plate, such that the external short circuit part may no longer be able to discharge the current charged in the electrode assembly by way of a short circuit. In such a case, safety of the unit battery cell and the rechargeable battery module may be endangered.

Embodiments provide a rechargeable battery module with enhanced safety while connecting unit battery cells in parallel.

Embodiment provide a rechargeable battery module that is capable of disconnecting parallel connections of the unit battery cells by inducing an external fuse of a bus bar and a cell fuse of a unit battery cell to be sequentially cut off by melting, before a membrane of an external short-circuit part is short-circuited with a connection plate and is then cut off by melting.

According to embodiments, the unit battery cells provided with the cell fuses may be connected through bus bars that form two current paths and resistances of the external fuses are set greater than those of the cell fuses. Accordingly, safety of the rechargeable battery module in which the unit battery cells provided with the external short-circuit parts are connected in parallel may be greatly enhanced.

According to embodiments, the external fuse provided with the bus bar may be cut off by melting first and then the cell fuse provided internally in the unit battery cell may be cut off by melting before the membrane of the external short-circuit part that is short-circuited with the connection plate is cut off by melting. Accordingly, the parallel connections may be cut off in a short-circuit state of the external short-circuit part.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope thereof as set forth in the following claims.

What is claimed is:

1. A rechargeable battery module, comprising
a plurality of unit battery cells and a bus bar connecting the unit battery cells in parallel, wherein each unit battery cell includes:
a cap plate sealing an opening of a case that accommodates an electrode assembly;
lead tabs connected to the electrode assembly, one of the lead tabs including a cell fuse;
first and second electrode terminals that penetrate the cap plate, the first and second electrode terminals being connected to the lead tabs; and
an external short-circuit part including a membrane that seals a short-circuit hole of the cap plate and that is electrically connected to the second electrode terminal and a connection plate that is electrically connected to the first electrode terminal,
wherein:
the bus bar includes two current paths that connect neighboring second electrode terminals through different resistances, one of the two current paths including an external fuse, and
a resistance of the external fuse is greater than a resistance of the cell fuse.

2. The rechargeable battery module as claimed in claim 1, wherein the bus bar includes a first connecting member that connects the neighboring second electrode terminals to form one current path of the two current paths, the first connecting member including the external fuse, and a second connecting member that connects the neighboring second electrode terminals to form another current path of the two current paths, the second connecting member having a resistance greater than the resistance of the external fuse.

3. The rechargeable battery module as claimed in claim 2, wherein:
the first connecting member includes a plurality of welding plates, each welding plate being welded onto the second electrode terminal of a respective one of the unit battery cells, and
the external fuse interconnects the plurality of welding plates.

4. The rechargeable battery module as claimed in claim 3, wherein the second connecting member is in a form of a plate that welded onto the welding plates of the first connecting member.

5. The rechargeable battery module as claimed in claim 4, wherein the second electrode terminal includes:
a rivet terminal in a terminal hole of the cap plate,
a flange integral with the rivet terminal at an inner side of the cap plate and
a plate terminal connected to the rivet terminal, the plate terminal being positioned at an outer side of the cap plate, one of the welding plates of the first connecting member being welded to the plate terminal.

6. The rechargeable battery module as claimed in claim 2, wherein the first connecting member is made of aluminum or an aluminum alloy.

7. The rechargeable battery module as claimed in claim 6, wherein the second connecting member is made of steel or stainless steel.

8. The rechargeable battery module as claimed in claim 1, wherein the external fuse includes a plurality of external fuses, a number of the external fuses being one less than an number of the unit battery cells such that each of the external fuses is correspondingly disposed between neighboring unit battery cells.
